(19) United States
(12) Patent Application Publication
(10) Pub. No.: US 2002/0043148 A1
(43) Pub. Date: Apr. 18, 2002

(54) Gripick

(76) Inventor: Clark Wilkinson, Whitethorn, CA (US)

Correspondence Address: Clark A. Wilkinson, P.O. Box 452, Whitethorn, CA, 95589, US

(21) Appl. No.: 09/735,133

(22) Filed: Dec. 11, 2000

Related U.S. Application Data
(60) Provisional application No. 60/170,703, filed on Dec. 14, 1999.

(51) Int. Cl. G10D 3/16

(52) U.S. Cl. 84/322

(57) ABSTRACT

Gripick™ is a liquid injection mold manufacture, that can be injected with a variety of materials.

The Trademark Gripick™ is engraved in mold with Grip Protrusions. Which protrude from Bevel. The Center of which, is a hole.

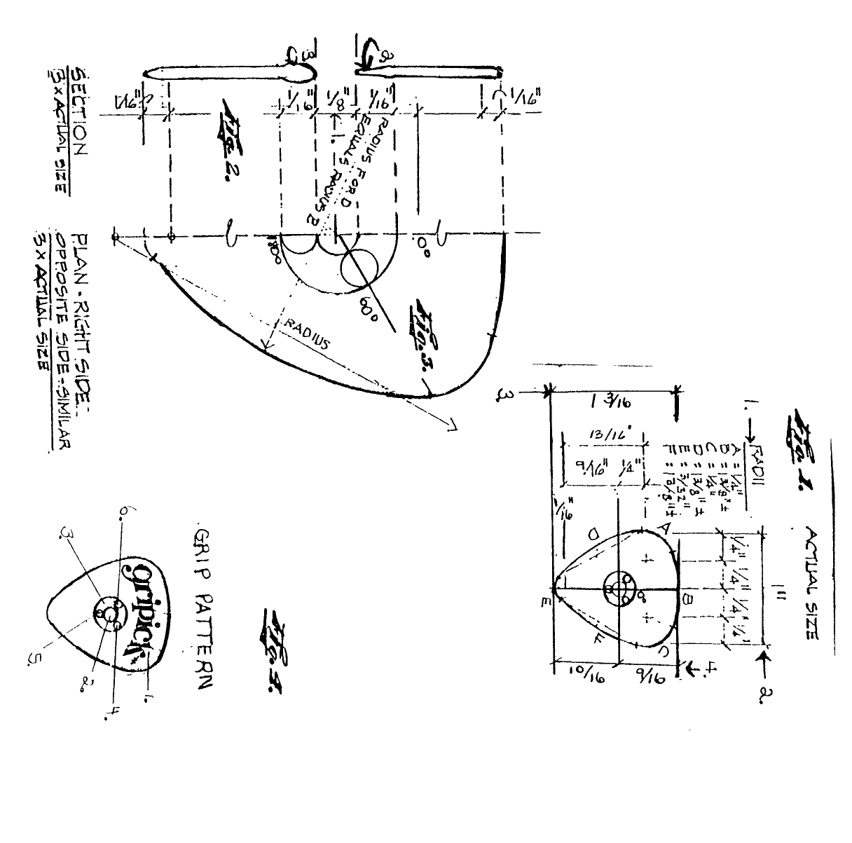

FIG. 1 on drawing, denotes the Specifications of the guitar pick.

FIG. 2 and FIG. 3 are viewed in proportion to each other denoting Center Hole, Bevel, Grip Protrusion and Pick Thickness.

FIG. 4 denotes the Parts of the Grip Pattern.

### BRIEF DESCRIPTIONS

FIG. 1. Pick Dimensions

1. Letters A thru F denotes radius specifications.

2. Pick measures 1″ wide.

3. Pick measures 1 3/16″ long.

4. Grip pattern measures 9/16″ from top to center 10/16″ center to bottom.

FIG. 2. Side View Section (3x actual size).

1. ⅛″ Center hold grip pattern.

2. Bevel 1/16″ from center O.D..

3. Grip protrusions (3) 1/16″ protruding 0.016″ out of bevel. 120° apart one at 60°, one at 180°, and one at 300°.

4. Thickness 1/32″.

FIG. 3. Plan Right Side (3x actual size)

in proportion to Side View (FIG. 2)

1. ⅛″ centerhold grip pattern.

2. Bevel 1/16″ from center O.D..

3. Grip protrusions (3) 1/16″ protruding 0.016″ out of bevel. 120° apart one at 60°, one at 180°, and one at 300°.

FIG. 4. Grip Pattern

1. Gripick ™ raised 0.016″.

2. ⅛″ center hold grip pattern.

3. Bevel 1/16″ from center O.D..

4. Grip protrusion @ 60°.

5. Grip protrusion @ 180°.

6. Grip pattern @ 300°.

### DETAILED WRITTEN DESCRIPTION

Gripick™ is an improved grip pattern designed to enable the player to hold the pick better, eliminating the chance of dropping the pick.

The Grip pattern consists my trademark Gripick™ engraved at the top of the pick, which protrudes above the surface of the pick. This area is where the thumb butt rests. I utilize my trademark at this height, in this area as a grip component. No other pick claims this. Some trademarks are in their molds but are flush with the surface, others are painted on.

The Gripick™ pattern consists of five claims Center Hole is located from center to pick bottom. Bevel measures out from Center Hole O.D.. With Grip Protrusions which protrude from the Bevel, each located apart.

The overall size of pick can be 20% larger or smaller than the original chauing.

The design allows the index finger to touch the thumb through the Center Hole, while in a beveled dish with three grip protrusions per side. Which grasps the finger tips and thumb. This Grip pattern eliminates the chance of dropping the pick and is like no other design claim.

Gripick™ is a liquid injected die mold that can be injected with a variety of materials. Enabling the flexibility of the pick to be determined by the material used.

### BRIEF SUMMARY OF INVENTION

Gripick™ is an improved grip pattern consisting of a hole, bevel, and raised grip protrusions along with Gripick™. Raised on a guitar pick, which eliminates the chance of dropping the pick. The design allows the index finger to touch the thumb thru a center hole. While in a beveled dish with grip protrusions which grasps the fingertips and thumb. No other guitar pick manufacture claims this design.

1. Trademark is engraved into mold.

2. Center hole is located from center to pick bottom.

3. A bevel measures out from center of pick.

4. Grip protrusions protrude from bevel located a part from each other.

5. Overall size of pick can be enlarged or reduced models of original drawing creating pick size variety.
